(19) United States
(12) Patent Application Publication
(10) Pub. No.: US 2015/0254406 A1
(43) Pub. Date: Sep. 10, 2015

(54) System and Method for Managing Cognitive Bandwidth to Prevent Failure of Valuable Tasks Requiring Cognition

(71) Applicant: Terry Rajasenan, Pittsburgh, PA (US)

(72) Inventor: Terry Rajasenan, Pittsburgh, PA (US)

(21) Appl. No.: 14/706,960

(22) Filed: May 7, 2015

Related U.S. Application Data
(63) Continuation-in-part of application No. 13/967,201, filed on Aug. 14, 2013.
Application No. 13/967,201 is a continuation of application No. 13/272,213, filed on Oct. 12, 2011, now Pat. No. 8,515,777.
(60) Provisional application No. 61/392,900, filed on Oct. 13, 2010.
(60) Provisional application No. 61/990,701, filed on May 8, 2014.
(60) Provisional application No. 61/991,014, filed on May 9, 2014.

(51) Int. Cl. G06F 19/00

(52) U.S. Cl. CPC G06F 19/327; G06F 19/3443; G06F 19/3481

(57) ABSTRACT

Cognitive bandwidth of a healthcare delivery team is managed by managing cognitive bandwidth of the healthcare providers and the overall support team for those providers on the healthcare delivery team. A performance improvement coordinator allocates health care delivery tasks and educational tasks to ensure that no healthcare provider or team member on the healthcare provider team reaches a tipping point to increase the likelihood that tasks at risks are performed adequately. Patient care tasks performed by the patient can also be considered by the performance improvement coordinator to avoid the patient reaching a tipping point that will adversely affect the patient's ability to learn and perform required patient care tasks effectively and efficiently.

The present application is a continuation in part of U.S. patent application Ser. No. 13/967,201, filed, Aug. 14, 2013 (pending), which is a continuation of U.S. patent application Ser. No. 13/272,213, filed Oct. 12, 2011 (now U.S. Pat. No. 8,515,777), which claims the benefit of U.S. Provisional Patent App. 61/392,900 filed Oct. 13, 2010 (now expired), each of which is incorporated herein by reference in its entirety, and the present application claims the benefit of U.S. Provisional Patent App. 61/990,701 filed May 8, 2014 (pending) and U.S. Provisional Patent App. 61/991,014 filed May 9, 2014 (pending), each of which is incorporated herein by reference in its entirety.

### BACKGROUND

1. Field of the Invention

Embodiments of the present invention relate generally to healthcare management. More particularly, embodiments of the present invention relate to managing cognitive bandwidth of healthcare providers to prevent failure of tasks at risk including managing learning of such healthcare providers.

2. Background

A problem with providing healthcare is that compliance to best practices requires task execution, for example, by healthcare providers performing healthcare delivery tasks to treat a patient preventing various symptoms. Task execution, in turn, is often performed using a checklist, or verified via checklist after performance of the tasks. Checklist compliance has been shown to improve patient safety, by preventing or reducing the severity of high mortality conditions such as sepsis, heart attacks, and traumatic brain injury that can result when task are not performed.

An example of the impact checklists can make in saving lives can be shown by the Central Line Associated Bloodstream Infection prevention safety checklist developed by Dr. Peter Pronovost, a critical care physician from Johns Hopkins. The checklist was developed at Hopkins in 2001, where it was introduced to reduce ICU central line infections. It was estimated to save 43 lives, and then applied more widely (for 18 months at a group of hospitals in Michigan), with estimated lives saved being 1,500. The cost savings were also substantial—an estimated $100 million in Michigan. The Central Line Associated Bloodstream Infection prevention safety checklist involved 5 key straightforward steps:

1. Wash hands

2. Clean site

3. Cover body

4. Wear mask

5. Cover site

However, a problem with using the checklist was that 33% of time at least 20% of the checklist tasks were dropped. These dropped tasks resulted in an 11% rate of bloodstream infection. To overcome this “Checklist fall-off,” healthcare providers made the Central Line Associated Bloodstream Infection prevention safety checklist the top checklist they considered.

Additional research that supports the risks associated with task execution failure performed by the University of Sydney and the University of New South Wales found that interruptions led emergency department doctors to spend less time on the tasks they were working on and, in nearly 1 in 5 cases, to lose track of the task altogether.

It has been found that multitasking and resulting cognitive overload are problems that impact how long it takes, over average times suggested by the Centers of Medicare and Medicaid Services, for physicians to discharge patients. See, e.g., Veluswamy, Ragupathy, “Golden Nuggets: Clinical Quality Data Mining in Acute Care,” Journal of the Physician Executive (May-June 2008). A key factor is that mortality risk appears to consume the most cognitive bandwidth. Not only are tasks on checklists related to a patient's immediate needs being “juggled” in a caregiver's (or a patient's) mind, but also tasks that are decision tree branches are being juggled. The problem with limited available cognitive bandwidth is magnified when physiologic disturbance, e.g. pain, hypoxia, etc. is involved. This is a key reason for the “anxiety” factor that constricts cognitive bandwidth. Thus, the higher the mortality risk of a particular case, the more people will think through decision tree branches (i.e. anxiety), and typically (given the complexity of those types of cases) the more decision tree branches there will be. As a result, the higher the mortality risk, the higher the cognitive bandwidth consumption. And, the cognitive consumption grows non-linearly with increased mortality risk. This means cognitive bandwidth decreases, and, as a result, tasks-at-risk increase.

In an embodiment, tasks-at-risk are identified as “appropriate” tasks that need to be performed due to their high “expected value” (i.e. the probability of a task failure multiplied by the negative cost or safety impact potentially caused by their failure). Performance of tasks-at-risk can be for example a care delivery task, such as performance of an item on a checklist or performance of an education task, such as teaching or receiving instruction concerning compliance or receiving instruction as to performance of a new care delivery task.

This increase in tasks-at-risk results from care team members not being able to “connect the dots” and synthesize data to do complex problem-solving often required in care. The impact is even more adverse for time-sensitive trauma and critical care situations.

This decrease in cognitive bandwidth can lead to cognitive overload, and an associated reduction in the ability to adequately analyze a situation. This so-called “fog of cognitive overload” impairs the ability of a healthcare provider to recall checklists, as well as the ability to think through decision trees to “connect the dots.” This fog leads to dropped tasks, which in turn leads to “preventable effort.” Preventable effort is unnecessary man-hours required to address problems resulting from the dropped tasks, which in the long term translates into a requirement for full-time staff, and, as a result, increases costs.

Air Force studies of pilot error similarly concluded that high levels of workload and stress increase the likelihood of pilot error, and recommended balancing load, avoiding surprises, and reducing anxiety. Being proactive was important, since that meant less anxiety, less cognitive load, less inertia, and less disruption. It was also noted that pilot performance, under most circumstances, is most reliable under moderate levels of workload and stress that do not change suddenly and unpredictably. See, e.g., Electronic Checklists on Multi-Purpose Displays: A better Way for Fighter Pilots to Manage Information and Situational Awareness during Periods of High Workload, Patrick J. Doherty, School of Advanced Military Studies, US Army Command and General Staff College, Fort Leavenworth, Kans.

### SUMMARY

That the problem of “Checklist Fall-Off” can be overcome by making it the highest priority checklist suggests that cognitive overload is a large factor leading to dropping tasks on a checklist. Thus, “Checklist fall-off” can be considered a risk (more detail found in FIG. 5). When viewed as a risk, cognitive load balancing can help reduce or eliminate the risk of “Checklist fall-off” Embodiments of the present invention improve checklist compliance by balancing cognitive load while training.

Embodiments seek to reduce cognitive overload on healthcare providers by considering the tasks at risk that are required for successful patient outcomes. Embodiments allocate tasks-at-risk to balance the cognitive load of healthcare providers available to treat the patients. Balancing the cognitive load in this manner avoids any healthcare provider reaching or exceeding tipping points, where the healthcare provider's cognitive bandwidth is consumed to the point where the effectiveness of the healthcare provider in treating the patient begins to decrease.

Importantly, the tasks considered in determining a healthcare provider's cognitive load are not limited to only tasks associated with healthcare delivery. Instead, tasks associated with training are also considered as learning consumes available cognitive bandwidth.

In an embodiment, a method for managing cognitive bandwidth of a team of healthcare providers includes process mining to determine symptoms presented by a patient, predicting healthcare delivery tasks required to treat the patient, determining a cognitive bandwidth of each healthcare provider available to treat the patient by reviewing tasks assigned to each healthcare provider by considering healthcare delivery tasks and educational tasks assigned to each healthcare provider, determining whether any of the healthcare delivery tasks or educational tasks are tasks at risk based on the determined cognitive bandwidth of each healthcare provider, and allocating any determined tasks at risk among the healthcare providers to avoid any of the healthcare providers from reaching a tipping point.

In another embodiment, a system for managing cognitive bandwidth of a team of healthcare providers, includes a healthcare demand module executing on a computer to perform process mining to determine symptoms presented by a patient and to predict healthcare delivery tasks required to treat the patient, a healthcare supply module executing on the computer to determine a cognitive bandwidth of each healthcare provider available to treat the patient by reviewing tasks assigned to each healthcare provider by considering healthcare delivery tasks and educational tasks assigned to each healthcare provider, and a performance improvement coordinator module to determine whether any of the healthcare delivery tasks or educational tasks are tasks at risk based on the determined cognitive bandwidth of each healthcare provider and to allocate any determined tasks at risk among the healthcare providers to avoid any of the healthcare providers from reaching a tipping point.

Additional features and embodiments of the present invention will be evident in view of the following detailed description of the invention.

### BRIEF DESCRIPTION OF THE DRAWINGS

FIG. 1 is a chart that compares learning in the striatum and the hippocampus.

FIG. 2 is a graph that illustrates checklist overload and how load balancing can reduce its negative effects.

FIG. 3 is a graph that illustrates the capacity limits in terms of tipping points for a team in an organization that must perform certain tasks.

FIG. 4 illustrates a database storage format for storing tipping point information for a particular healthcare provider in a healthcare organization.

FIG. 5 illustrates a system for managing cognitive bandwidth by allocating tasks according to an embodiment.

FIG. 6 is a flow chart for a method for managing cognitive bandwidth by allocating tasks according to an embodiment.

FIG. 7 is a graph that illustrates optimal performance in terms of performance as a function of task allocation according to an embodiment.

FIGS. 8A-8D illustrate load balancing taking into consideration both number of tasks allocated and spacing of allocated tasks.

FIG. 9 illustrates graphically dimensions of task fungibility.

FIG. 10A illustrates exemplary tasks that are performed in a healthcare facility for a particular patient.

FIG. 10B illustrates how the tasks shown in FIG. 10A might be assigned to an exemplary healthcare provider team according to a conventional allocation.

FIG. 10C illustrates the tasks shown in FIG. 10A reallocated to create a balanced task load according to an embodiment.

FIG. 11 is a block diagram of an example computer that may be used to implement the apparatus and methods described herein according to an embodiment of the present invention.

### DETAILED DESCRIPTION

One reason for the opportunity involves the reason multi-tasking affects learning. Different types of memory are processed by separate systems in the brain. Memory retrieval for tasks such as remembering names, numbers, or even what a person did last week is from “declarative” memory. Declarative memory relies on parts of the brain that store learned facts and concepts. Alternatively, when a person tries to remember how to ride a bike or play basketball, the person uses “procedural” memory. Procedural memory uses a different part of the brain than declarative memory.

One study by psychologists used distractions and multitasking to disrupt learning, which led to subjects' memories not being stored in their declarative memories but rather their procedural memories. As a result, when the subjects needed to call up the learned tasks, their memories were faulty and incomplete. The psychologists demonstrated the roles the specific parts of the brain played in the distracted learning. For subjects who learned their tasks without distraction, the hippocampus—the part of the brain that plays a critical role in processing, storing and recalling information—was involved. The hippocampus is necessary for declarative memory. For the tasks learned with distraction, the striatum, not the hippocampus, was involved. The striatum is the brain system that underlies the ability to learn new (usually repetitive) skills. If the brain relies more on the striatum, the learning will be more difficult to recall and be applied in new situations. See, e.g., Multi-Tasking Adversely Affects the Brain's Learning Systems by Russell Poldrack, published at http://www.psych.ucla.edu/news/russell-poldrack-multi-tasking-adversely-affects-the-brains-learning-systems.

Research based on the use of functional MRIs has shown that different parts of the brain are used when multitasking as compared with focus on a single activity. This is because multitasking often involves repetitive behaviors that are processed in the striatum rather than the hippocampus. However, if information is to be recalled and applied, the hippocampus, which plays an active role in long term memory, must be involved. In other words, when learning with multitasking, the striatum is used, which is not best suited for long term memory and understanding. Thus, learning with Multitasking appears to result in a superficial understanding of the studied material. As a result, learning with multitasking reduces one's ability to learn, resulting in weak transfer to other settings. That is not to say no learning occurs with multitasking. However, such learning is less flexible, more specialized, and harder to retrieve when needed—which can be very detrimental in the time-sensitive situations found in healthcare, especially trauma and critical care. Thus, learning while performing habitual or repetitive tasks leads to knowledge that cannot be generalized as well, for example, to apply to new situations.

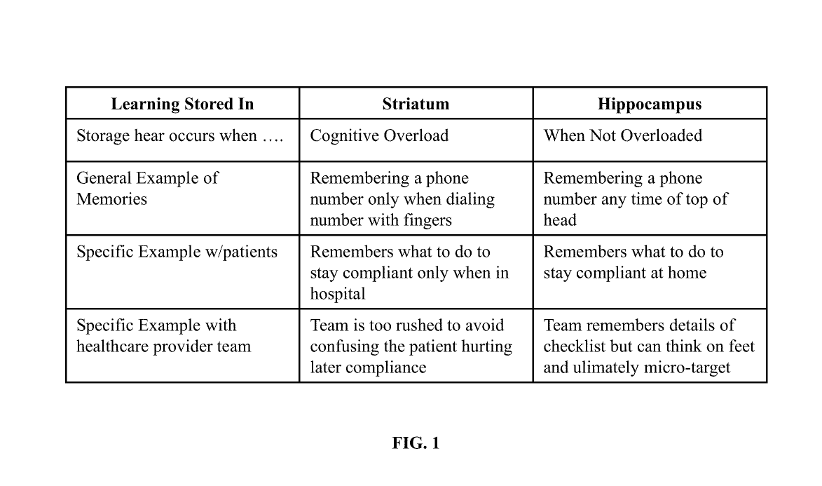

FIG. 1 is a chart that summarizes learning in the striatum and the hippocampus. As can be seen from the chart in FIG. 1, at the point of cognitive overload, inefficient learning in the striatum takes place, whereas efficient learning takes place in the hippocampus when there is no cognitive overload. The chart of FIG. 1 also provides examples of the types of memories that are in the striatum and the hippocampus. For example, remembering a phone number when only dialing with the fingers involves the striatum, whereas being able to recall the phone number at any time involves the hippocampus. With respect to patients, an example of each type of memory is remembering what tasks to perform to stay compliant with doctors' orders while in the hospital involves the striatum, whereas the ability to remember what tasks to perform to stay compliant with doctors' orders once discharged and at home involves the hippocampus. With respect to healthcare providers, when the healthcare providers are overloaded and, for example, rushed, they use the striatum, and therefore are more likely unable to remember checklists or to be able to respond to patient questions, which is likely to confuse the patient and hurt later patient compliance, whereas if healthcare providers are not overloaded, they use the hippocampus and therefore, they are more likely to be able to remember a checklist, as well as respond to patient questions faster and communicate it more directly and effectively.

This dichotomy of learning helps explain why there is likely to be better learning and compliance using better load balancing of cognitive load during the learning process. That is, when healthcare team members are not distracted, for example, due to being rushed and thinking of needing to move to the next patient, they generally perform tasks required for a successful patient outcome. Similarly, when patients are not distracted, for example, thinking about leaving the day of the discharge, they are more likely to absorb, retain, and recall discharge instructions they are given, and therefore better able to comply with those instructions. For example, patients who are not distracted when being given instructions are more likely to be compliant for tasks such as taking medications properly. Patients who comply with discharge instruction are less likely to require readmission back to the hospital, and therefore likely to reduce costs.

This is also important because it leads to a paradox with using checklists. Using too few checklists raises risk of a bad outcome. But, due to cognitive overload, whether caused by anxiety or distraction, so does using too many checklists. That is, cognitive overload leads to dropped tasks-at-risk, which necessitates the use of checklists to confirm required tasks are performed. However, trying to remember and follow checklists beyond the cognitive capacity of individuals leads to cognitive overload, which in turn leads to dropped tasks.

Thus, learning checklists while having to do too many care delivery tasks, or while having to remember too many already-learned checklists, is the equivalent of learning while distracted. As a result, task failure is likely to be higher with requirements to learn more and more checklists. Another reason for load balancing during practice-based learning (where learning tasks and healthcare delivery tasks take place concurrently) is that learning too many checklists leads to a mental multitasking when the care team member or patient needs to solve problems or do complex tasks. This can lead to “checklist overload”, which reduces the effectiveness of subsequent checklists.

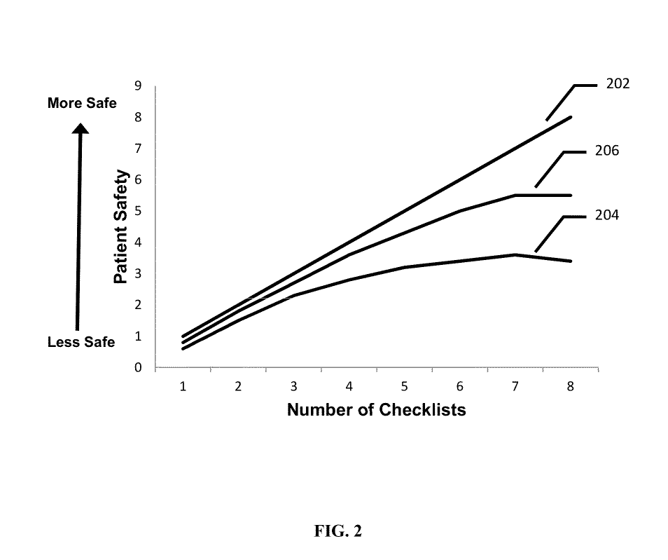

Thus, keeping team members below their tipping point, i.e, below cognitive overload, reduces the need for checklists, because their task execution should be better. As a result, there is less quality assurance is required when team members have sufficient bandwidth to recall tasks and connect dots. FIG. 2 illustrates patient safety versus number of checklists to illustrate checklist overload and how load balancing can reduce its negative effects. In FIG. 2, patient safety is assumed to be dependent upon adherence to checklists. Curve 202 illustrates ideal patient safety where patient safety would increase linearly with the number of checklists. Curve 204 demonstrates patient safety in conventional systems where there is no cognitive load balancing. As seen in curve 204, there is a diminishing point of return and fall-off in safety when health care providers (or patients) must try and remember, and execute, too many checklists (i.e. “checklist overload”). Curve 206 illustrates the gains in patient safety by load balancing of cognitive capacity through better health care provider team coordination, which reduces this checklist fall-off.

In an embodiment, determining “checklist fall-off” uses process mining and tipping point analysis. To make the determination, embodiments evaluate historical data associated with various task performance metrics and analyze the cognitive bandwidth of healthcare providers to perform tasks to determine the likelihood that tasks will be completed by the healthcare provider assigned to the task. Cognitive bandwidth is cognitive capacity less cognitive load. Such analysis allows prediction, in advance, of which crucial clinical tasks will be dropped, by whom, when and why. The problem is typically large in scope (as it requires understanding of the cognitive overload points of personnel from as many of healthcare providers in an organization as possible). Using process mining and tipping point analysis provides a significant improvement over conventional systems that offer only two choices for process failure: (1) train those that erred, or (2) discipline them. With process mining and tipping point analysis, the two options become: (1) maybe train those that erred, (2) take action to support them to reduce their cognitive load to just below each person's tipping points. Support in this context includes using different education environments while training under stress, having more support resources, improving processes, or planning the balancing of cognitive load—as proactively as possible.

One difference of using process mining with tipping point analysis is that process mining coupled with tipping point analysis considers the realities of cognitive limits, rather than the unrealistic expectation of, or unsustainable reliance on, constant “overachievers.” Moreover, process mining and tipping point analysis demonstrate that the difference between the training vs. too much juggling problems is important to cost-effectiveness in learning and execution, since solutions to problems of concern can be implemented. Understanding cognitive overload is important because it is not always evident when cognitive overload occurs, and for whom and under what circumstances. Without such understanding, the additional education may waste productive hours for trainers—and trainees.

More importantly, given human cognitive capacity limits under high load, conventional training is unable to solve the problem on its own. That is, when a person reaches his or her “tipping point,” the amount of training they have becomes irrelevant. The tipping point is the point at which a healthcare provider has reached his or her capacity to supply healthcare service at an acceptable quality. Beyond the tipping point, task performance begins to degrade disproportionately with cognitive load increases. As a result, once a person's reaches his or her tipping point, the likelihood that person can successfully complete an additional task decreases rapidly. Put another way, the risk of that person performing the task unsuccessfully or simply not getting to it becomes unacceptably high. This has significant impact when the tasks are “high impact” when not done correctly, and thus considered high value.

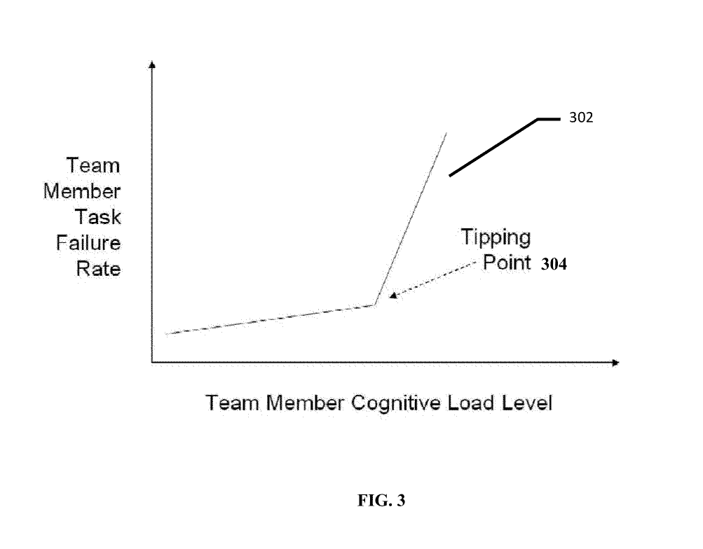

FIG. 3 is a graph that illustrates the capacity limits in terms of tipping points for a team in an organization that must perform certain tasks. Curve 302 illustrates exemplary task failure rate of a healthcare provider as a function of cognitive load. As shown in FIG. 3, the tipping point 304 occurs where task performance suffers disproportionately to load increases is the estimated cognitive capacity limit. Once tipping point 304 is exceeded, additional tasks result in a disproportionate failure rate.

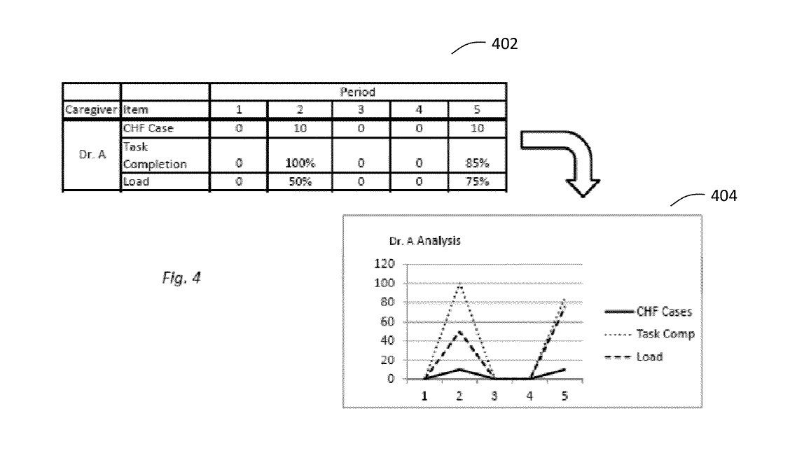

FIG. 4 illustrates a database storage format 402 for storing tipping point information for a particular healthcare provider in a healthcare organization according to an embodiment. For example, as shown in FIG. 4, the information stored in database storage format 402 includes the type of cases the healthcare provider is responsible for, the task completion rate for the healthcare provider and the cognitive load level for the healthcare provider. This information is stored over time. Thus, for each of a number of periods, the information stored in the database includes the number of each type of case for which the healthcare provider is responsible, the task completion rate for the cases, and the cognitive load during the period. In an embodiment, the database includes similar information each healthcare provider in the healthcare organization.

The information stored in the data is used by checklist scoring models and tools. For example, as shown in FIG. 4, the information is used to generate trend lines 404 from which tipping points can be determined for individuals and/or healthcare teams as shown in FIG. 3. That is, this process mining and tipping point modeling enables estimation of the tipping points of team members.

What becomes clear by the information in a database such as shown in FIG. 4 for each healthcare provider in a healthcare organization is that individual cognitive capacities (before an individual drops one or more specified tasks at a significantly higher rate that is not linear) vary greatly between individuals, even those with equal training. Thus, tipping points vary greatly for individuals within a healthcare organization. By considering individual cognitive capacities and tipping points, embodiments overcome the conventional wisdom that simply training individuals is sufficient.

For example, using the database information stored for each healthcare provider in the healthcare organization, embodiments of the present invention compare learning with load balancing (where the learning retention of checklist tasks and thus the recall of them are higher) versus without load balancing (where recall is lower) of people individually doing care delivery tasks in practice-based learning setting, simulating a live setting in an emergency department (“ED”) or intensive care unit (“ICU”). In this example, the data can be used to help determine how well the person would have learned the material they were supposed to learn, and how it may need to be reinforced (e.g. in a undistracted classroom setting) and how many more times it needs reinforced. Moreover, this learning while load balancing of the team leads to safer task execution of care delivery tasks, reducing the anxiety of the team members, and thus reducing cognitive overload further, and thus enhancing learning even more.

In an embodiment, scoring models determine tipping points using performance metrics. One such metric is failure-to-rescue (“FTR”) rate. FTR includes both a failure to recognize and a failure to act. FTR may be caused by inadequate available cognitive bandwidth (cognitive capacity limit minus cognitive load) during checklist execution. Load balanced training can help increase cognitive bandwidth as it increases the quality of the learning and memory recall later. In short, load balancing raises a healthcare provider's capacity limit (or tipping point).

In embodiments, cognitive overload represents the point where mental processing capability drops significantly and non-linearly, or even precipitously. One way in which cognitive overload manifests itself is a significant, disproportionate increase in task failures relative to cognitive load as shown by the tipping point in FIG. 3. As such, cognitive overload adversely affects learning and compliance, for example reduced checklist compliance by healthcare providers or reduced medication compliance by patients. Further, overloaded healthcare teams lead to overloaded patients that do not learn well, and thus cannot stay compliant. As a result of their noncompliance, they are often readmitted. Thus, patient learning is impacted by overload, whether the overload is that of the healthcare provider or the patient. This reduction in the ability of patients to learn results in reduced after stay compliance, which results in readmission.

The same is true of healthcare teams (physicians, nurses, and others that may support them) that are treating trauma and critical care patients. Improving healthcare team learning by increasing cognitive bandwidth should improve compliance, which should then reduce FTR, as well as complications, and mortality rates.

Tipping points for overload and underload are calculated for each healthcare team member through retrospective analysis. Once tipping points are calculated, they are stored in the database. After the tipping points are stored, in an embodiment, load balancing while learning is addressed by a Performance Improvement Coordinator (PIC). The PIC assigns both already learned tasks (e.g. procedures, diagnosing) by healthcare providers as well as new and not yet learned tasks by healthcare providers. This assignment places cognitive load of care delivery tasks, as well as the learning tasks, on the healthcare provider. Once such tasks are assigned, in embodiments, load balancing is performed on the assigned learning tasks and care delivery tasks of healthcare providers to improve healthcare provider learning. Load balancing attempts to reallocate tasks among available healthcare providers in an organization to avoid overload or underload of cognitive capacity for a particular healthcare provider. Because the load balancing considers both learning tasks and care delivery tasks, cognitive bandwidth will be available for learning new tasks, while still delivering safe patient care. The improved learning, in turn, raises healthcare providers cognitive bandwidth, and therefore, their calculated tipping points, which will reduce the need for additional staff, and ultimately reduce costs in the healthcare organization without sacrificing quality of care.

In an embodiment, the PIC is a module that executes on a computer that performs the required load balancing of tasks. The PIC improves the performance of the computer on which it executes by allowing the computer to allocate and/or reallocate tasks among healthcare providers to avoid tipping points, and therefore increase the likelihood of successful patient outcomes.

The PIC allocates the tasks at risk among available healthcare supply based on cognitive load of the available healthcare supply. For example, in an embodiment, the PIC considers the current cognitive load of each healthcare provider as well as the additional cognitive load load that would be imposed on each healthcare provider if tasks to treat the patient were to be allocated to that healthcare provider to allocate tasks to ensure that no healthcare provider reaches or exceeds their tipping point, and thereby increase the likelihood that tasks at risk are not only performed, but are performed adequately. In an embodiment, the PIC also considers the additional cognitive load of training when considering allocation of tasks to avoid tipping points. In this manner, the PIC can allocate learning tasks in addition to healthcare delivery tasks while maintaining safe delivery of patient care. In addition, in an embodiment, the PIC allocates tasks to ensure that no healthcare provider is given too few or too many tasks.

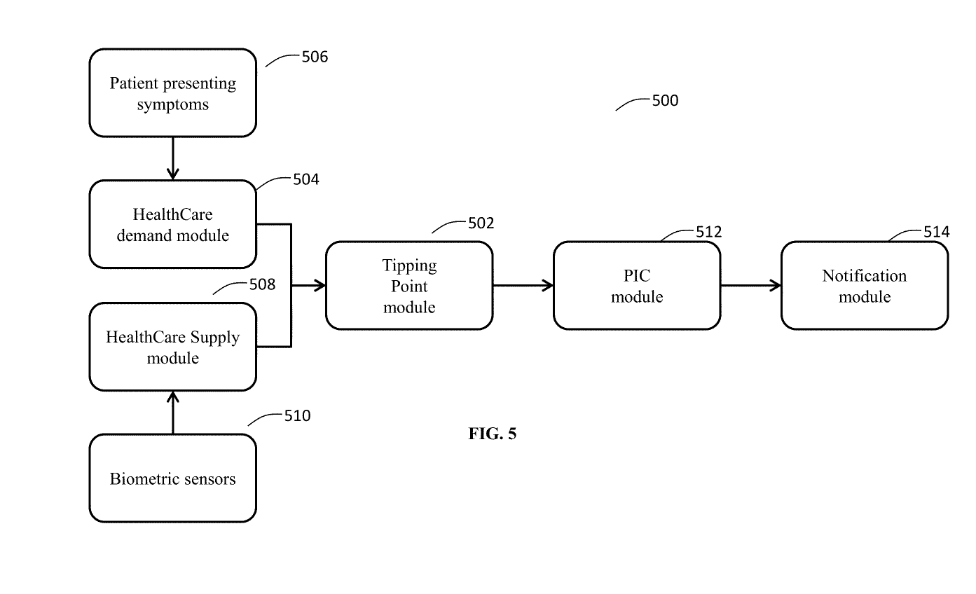

FIG. 5 illustrates a system 500 for managing cognitive bandwidth by allocating tasks according to an embodiment. System 500 can be implemented on a computer, such as computer 1110, configured with the described modules. The computer can be connected to a network (e.g., Internet, intranet, LAN, WAN, etc.) so the modules can obtain information, such as patient symptoms and diagnoses, from other computers on the network. When located on another computer, the information is accessed via a network.

In the exemplary embodiment illustrated in FIG. 5, a healthcare demand module 504 inputs patient presenting symptoms 506 (and can also include lab results, radiology test, and other patient health data sampled over time). In an embodiment, this is done using process mining, for example, lexical analysis of intake reports that include symptoms presented by patients. Other sources for patient presenting symptoms, such as ER reports, patient intake interviews, etc., can also be used. These sources can be located on a on a mass storage device connected to system 500 or stored on one or more computers that are located locally or remotely to system 500. When the sources are stored on another computer, they are accessed via a network.

Healthcare demand module 504 determines tasks that are required based on the symptoms. For example, in an embodiment, healthcare demand module 504 predicts the required tasks based on the presenting symptoms by accessing one or more databases that correlates symptoms with a diagnosis. The database(s) also correlate each diagnosis with an in house best practices (“IHBP”) checklist that contains tasks to perform to treat the diagnosis for the resources available in the organization, so that the best practice is practical in the organization, and not simply a best practice that worked well at another facility with a different set of resources and consequent capabilities. The database(s) can be located on a on a mass storage device connected to system 500 or stored on one or more computers that are located locally or remotely to system 500. When the database(s) are stored on another computer, they are accessed via a network.

Healthcare supply module 508 determines the available healthcare supply that can be used to handle the tasks. In an embodiment healthcare supply can be determined based on a number of factors including healthcare providers and their capabilities, and available healthcare resources, including for example, available equipment, rooms, and other facilities. In an embodiment, real time analysis of healthcare provider physical attributes provided by biometric sensors 510. The real time biometric data is used in an embodiment to provide a real time indication of stress levels, which affects cognitive capacity. For example, the higher the stress, the less a person is able to function efficiently, that is, the lower their cognitive capacity. Other sensors can be found in smartphone devices (e.g. accelerometers, time-keeping devices, GPS tracking devices, etc.), and even from the data available on various systems like time clock systems, and information systems that note who is in the hospital, and how many patients they are assigned to, taking notes on, etc.

Using the determinations from healthcare demand module 504 and healthcare supply module 508, tipping point module 502 determines tipping points for each available healthcare provider based on their cognitive bandwidth and current actual and/or predicted cognitive load. Using the determined cognitive bandwidth information, healthcare supply module 508 determined which tasks are tasks at risk. This information is provided to a PIC module 512 to allocate required tasks to available healthcare providers to avoid tipping points, and thereby ensure tasks at risk are completed to increase patient safety and successful outcomes. To allocate the tasks, PIC module 512 assigns tasks through a notification module 514. For example, notification module 514 can send email messages, text messages, telephone calls or other notifications to healthcare providers to assign tasks and reallocate tasks, including assigning and reallocation in real time. Additionally, notification module 514 can make daily activity reports to assign daily tasks.

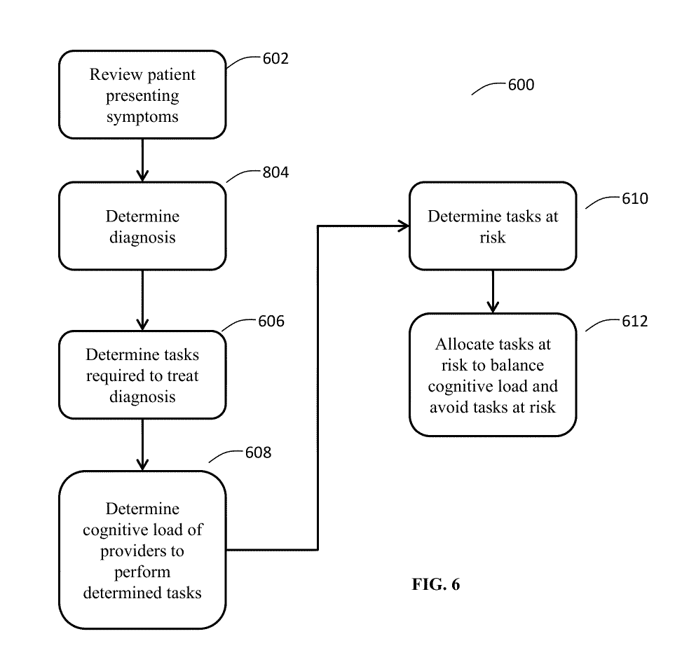

FIG. 6 is a flow chart 600 for a method for managing cognitive bandwidth by allocating tasks according to an embodiment. System 600 can be implemented on one or more computers, such as computer 1110, configured with the described steps. In step 602, the symptoms a patient presents are reviewed. In an embodiment, this is done using process mining, for example, lexical analysis of sources of patient presenting symptoms as described above. In an embodiment, this is accomplished by comparing the patient presenting symptoms to a database that identifies likely diagnoses based on presenting symptoms to predict the appropriate diagnosis. In step 606, tasks are determined to treat the patient based on the diagnosis. In an embodiment, the tasks are determined based on IHBP checklists that identify tasks to perform to treat a patient having the predicted diagnosis. In step 608, the cognitive load of healthcare providers that can perform the task is determined. In an embodiment, the cognitive load is comprised of the cognitive load associated with provided care as well as the cognitive load associated with training requirements. In step 610, tasks at risk of not being completed due to healthcare providers reaching tipping points as a result of being assigned the particular task to perform are determined. In step 612, tasks required to treat the patient are allocated to ensure tasks at risk are completed.

In an embodiment, cognitive load is calculated and measured (based primarily on mortality risk), and overload/under-load, using process mining and tipping points. Process mining and tipping point analysis is described in more detail in U.S. Pat. No. 8,073,731, entitled, “Method and System for Improving Efficiency in an Organization Using Process Mining,” which was filed on Nov. 22, 2006 and issued on Dec. 6, 2011, U.S. Pat. No. 8,407,081, entitled “Method and System for Improving Efficiency in an Organization Using Process Mining”, which was filed on Nov. 28, 2011 and issued on Mar. 26, 2013, and U.S. Pat. No. 8,515,777, entitled, “System and Method for Efficient Provision of Healthcare,” which was filed on Oct. 12, 2011 and issued on Aug. 20, 2013, each of which is incorporated by reference herein in its entirety.

In an embodiment, use of a PIC to proactively assign tasks and put team members on standby improves throughput, safety, and patient satisfaction. Further, it improves peak capacity (for example, number of patients treated per healthcare provider). PIC load balancing also improves healthcare provider satisfaction because they do fewer, albeit more high value, tasks that make a difference in the care process and outcomes of patients. Thus, use of a PIC substantially improves productivity.

It is important to understand that load balancing in embodiments, is not limited to consideration of the number of tasks (not too many, but not too few), but also the timing of those tasks. That is, cognitive bandwidth is also related to the “spacing” or timing of tasks. Allowing too little time between tasks can lead to the same anxiety and distractions that result in task failure. On the other hand, allowing too much time between tasks can lead to failure for among other things forgetting how to do the task. Appropriate spacing of tasks is important to learning and retention, and therefore important to later recall.

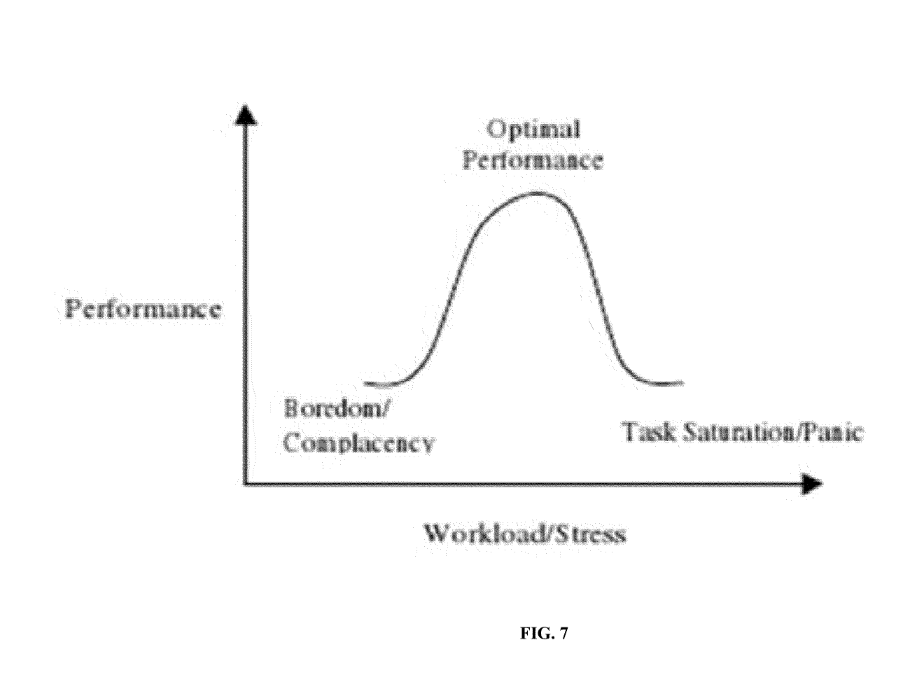

FIG. 7 is a graph 700 that illustrates optimal performance in terms of performance as a function of task allocation according to an embodiment. As shown in FIG. 7, tasks should be allocated so that individuals have enough work to avoid boredom or complacency, but not so much that they are overloaded and reach tipping points resulting in task saturation and panic. Thus, optimal performance is achieved where there individuals are assigned sufficient tasks to keep them interested or involved, but not so many tasks that they become overburdened, such that they reach a tipping point and begin to drop tasks or not perform them sufficiently.

Load balancing according to embodiments can be applied to patients who may have patient care tasks to perform as well. For example, patient care tasks can include taking medications and visiting a primary care physician for checkups after discharge. These tasks can become tasks at risk if the patient is unable to learn them due to reaching a tipping point, whether causes by a distraction such as pain or fatigue or caused by having too many things to learn at once. Applying cognitive load balancing to patients (using tipping points analysis applied to patients) significantly improves their compliance, which leads to fewer readmissions and increased time between readmissions. According to an embodiment, cognitive load balancing of these patients involves several steps. Initially specific needs of patients are identified upon admission to the healthcare facility. In an embodiment, this identification is accomplished using work lists and notifications from existing systems. In an embodiment, patient training tasks to address those needs are spaced in smaller training sessions each day, with fewer tasks to have to learn.

In an embodiment, “micro-targeting” can be used to find the patient care tasks that have been a challenge for the patient based on past data. For example, if the patient had no problem with their medication compliance, but failed to comply with seeing their primary care physician, rather than going to the emergency department, the learning patient learning task is geared toward ensuring compliance with seeing the patient's primary care physician. For example, instructions are given as to how to contact primary care clinic staff. In addition, instructions are given as to contacting hospital outreach personnel that can assist the patient in setting up an appointment with the patient's primary care physician faster and more easily. Alternatively, the compliance could be on diet, or activities, etc. By micro-targeting to identify the tasks most likely to fail, only those tasks most critical to a successful outcome (in this case reducing patient readmission) are included in load balancing. Thus, micro-targeting lessens load (and thereby increases bandwidth available before reaching the tipping point and thus cognitive overload, which will then also improve retention of what is being taught) on both the trainer and “trainee” (i.e. the patient) to get them to remember what to do once they are discharged.

The approach of embodiments of better load balancing by considering both the amount of load (not too much, not too little) and spacing of that load (not too much all at once that it doesn't get assimilated, but not spread out too far that it does not get reinforced) improves patient compliance both because healthcare providers are better able to teach and patients are better able to absorb. In the past, readmission patients many times had only themselves to execute the tasks—that is, there was a “small footprint” team available to execute the tasks. Moreover, patients often view these tasks as complex, since they typically have to understand when, how, how much, and why in order to take a particular medication properly Of course compliance, such as properly taking medications is tied to the patient staying healthy and out of the hospital.

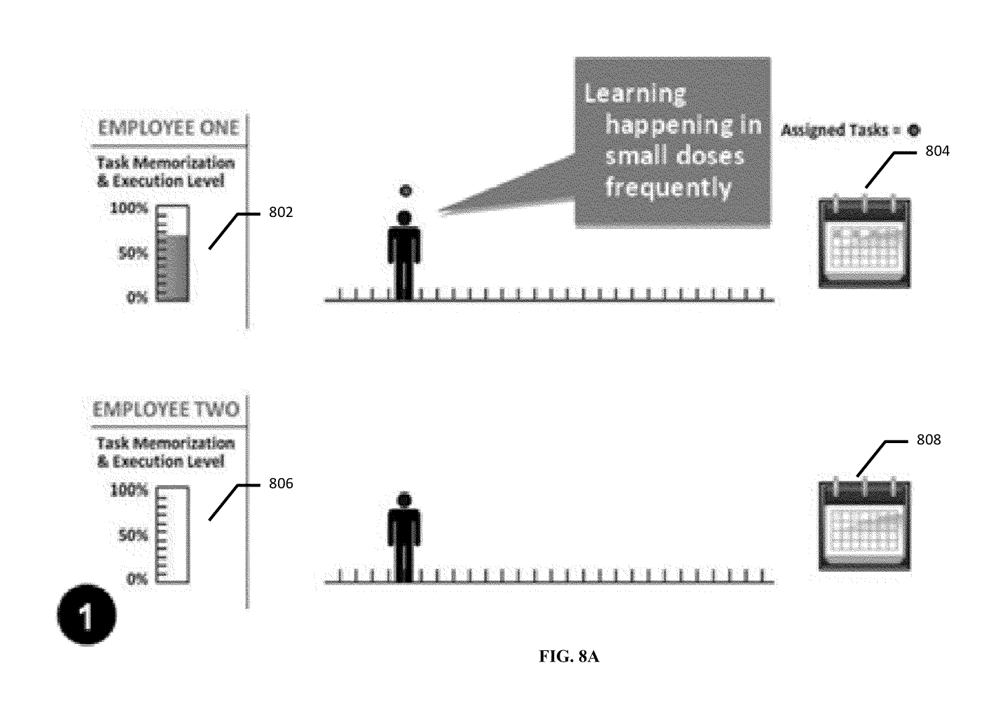

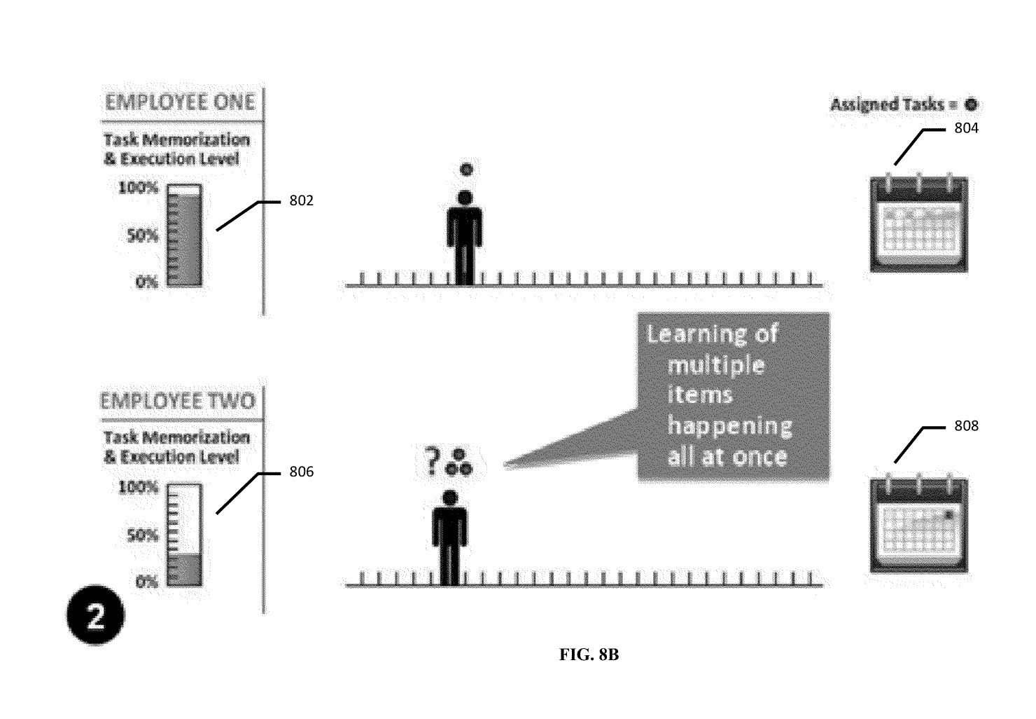

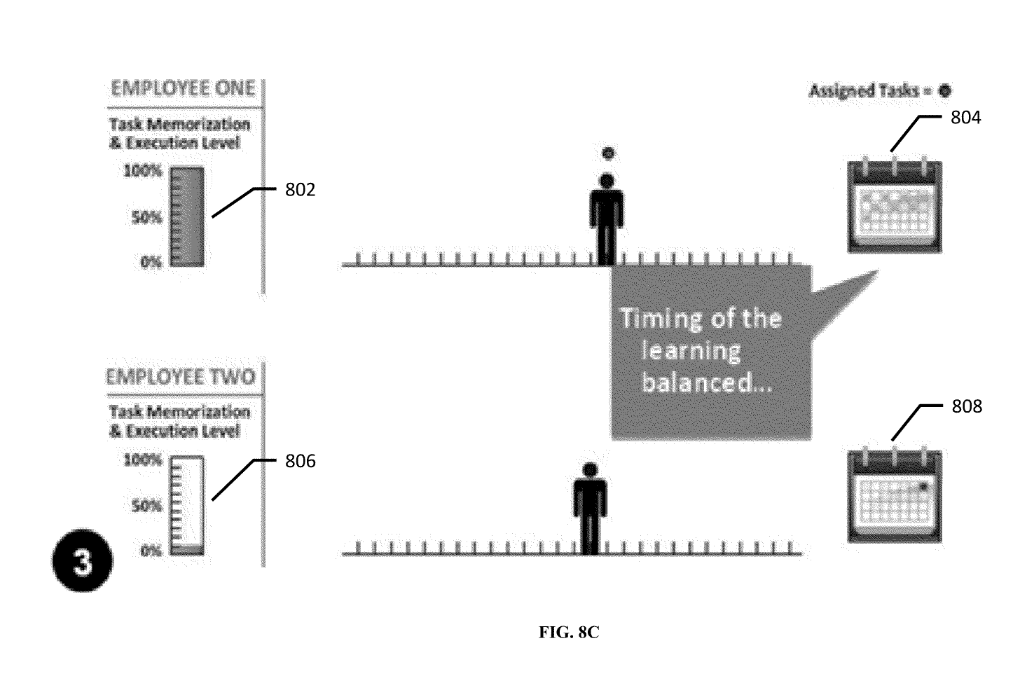

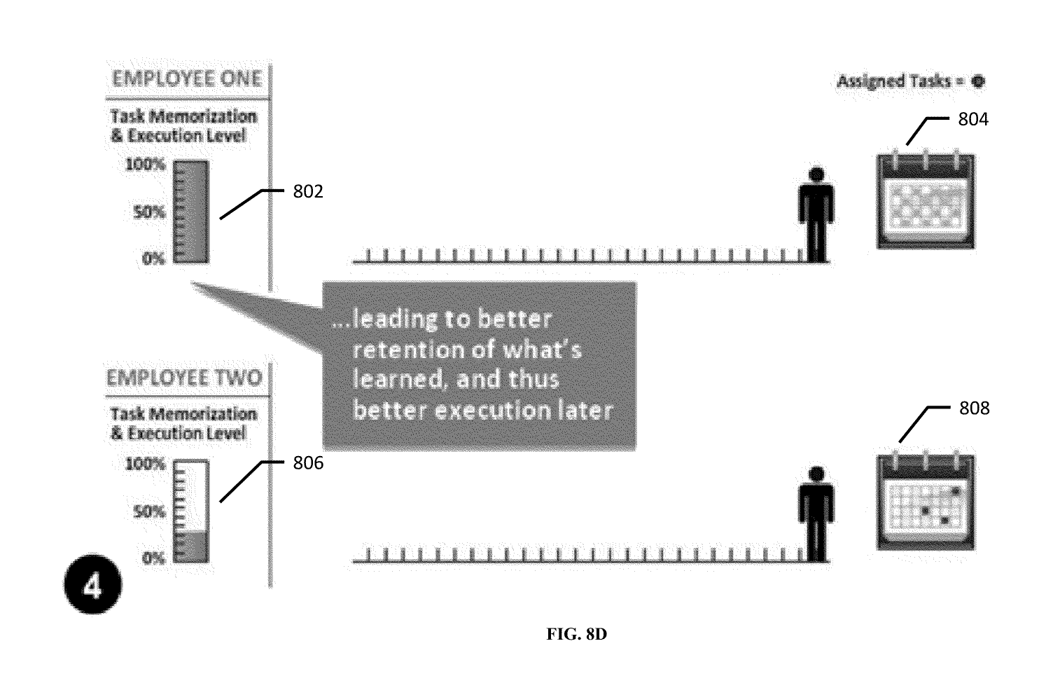

FIGS. 8A-8D illustrate load balancing taking into consideration both number of tasks allocated and spacing of allocated tasks. FIG. 8A demonstrates how frequent, but small, doses of learning improve task memorization and execution. As shown by learning schedule 804 of FIG. 8A, employee 1 is exposed to more frequent, but small, doses of learning. As shown by exemplary learning meter 802, employee one has a learning retention and execution of approximately 75%. As shown by exemplary learning meter 806 and schedule 808 for employee 2, task memorization and execution is significantly less when trying to learn multiple items all at once. As shown by exemplary learning meter 802 and schedule 804 for employee 1 in FIG. 8C, task learning can be improved even further when learning tasks are appropriately balanced to account for cognitive load. As a result, as illustrated further in FIG. 8D, task memorization, and subsequent task execution is significantly improved for employee 1, when compared to employee 2, for whom conventional assignment of learning tasks with no load balancing is applied.

Finally, for each task identified as a task at risk, the appropriate task force member is notified about the need to undertake the care delivery task, including teaching of the task the patient needs to learn. For instance, if the patient is polypharmacy (i.e. takes multiple meds) then a person specially trained in pharmacy should be involved in the care delivery/teaching. However, if the patient is not, then that pharmacist's time (and cognitive bandwidth) should not be set aside and consumed for the patient. Such micro-targeting resources to handle tasks-at-risk significantly improves productivity of the team and the effectiveness of their efforts.

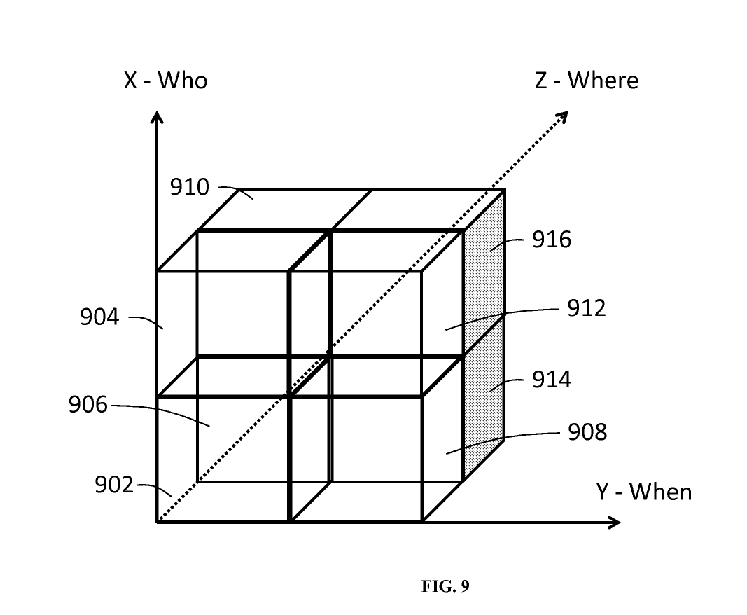

In load balancing according to embodiments, which tasks can be moved to reduce tasks assigned, and thus cognitive bandwidth consumed, of a team member is determined. This in turn requires determining which tasks are fungible. FIG. 9 illustrates graphically eight dimensions of task fungibility along 3 axes: (1) X— who is to perform a task, (2) Y—when the task is to be performed, and (3) Z—where the task is to be performed. Tasks in octant 902 are not fungible. That is, tasks in octant 902 must be performed by a certain person at a certain time in a certain place. Tasks in octant 904 are fungible in terms of person who can perform the task. That is, tasks in octant 904 can be performed by more than one person, but still must be performed in a certain place at a certain time. Tasks in octant 906 are fungible in terms of where the task can be performed. That is, tasks in octant 906 can be performed in more than one place, for example, remote health or telehealth, but must be performed by a certain person at a certain time. Tasks in octant 908 are fungible in terms of time. That is, tasks in octant 908 can be performed at different times, but must be performed by a certain person in a certain place. Tasks in octant 910 are fungible in terms of who can perform the task and where. That is, tasks in octant 910 can be performed in more than one place by more than one person, but must be performed in a certain place. Tasks in octant 912 are fungible in terms of who can perform the task and when. That is, tasks in octant 912 can be performed by more than one person at more than one time, but in a certain place. Tasks in octant 914 are fungible in terms of where the task can be performed and when the task can be performed. That is tasks in octant 914 can be performed at multiple times and multiple places, but must be performed by a certain person. Tasks in octant 916 are the most fungible. That is, tasks in octant 916 can be performed by multiple people, in multiple places, and at multiple times.

A care delivery or learning task that can be moved from dimensions of person, place, or time is fungible. To shift tasks from overloaded team members to those with available cognitive bandwidth, and thus reduce the risk of task failure by those overloaded team members, tasks must be transferred away from the overloaded person. These may not be the actual tasks that typically fail for this person when they overload, but instead may be other tasks that can simply reduce the cognitive load and thus increase cognitive bandwidth. But these tasks must be defined in advance for their “transferability”, and certain tasks may only be able to be done by a certain person (and cannot be simply transferred to another person, given such reasons as they may have less training), in which case they need to be done by that person at a different place (e.g. remotely, via telemedicine) or done at a different time by that person.

In an embodiment, fungibility depends on the expected value of return on investment (“EVROI”) of reallocating a task. In an embodiment, EVROI is determined by considering the nature of the task and the overload risk of the person performing the task. EVROI is higher the more important the task to improving outcomes if the task is done (or its adverse impact if not done) and the more likely it is to be performed (i.e. its probability of being performed to achieve that outcome value).

Thus in an embodiment, a PIC can look at tasks and determine the EVROI for doing that task. Then, the PIC determines whether to reallocate tasks other team members to avoid the likelihood or risk of any team member reaching their tipping point, overloading, and not completing high value tasks. In embodiments, task allocation requires assurance that not only does a person to whom a task would be reallocated has some level of competence to complete the task, but also that the physician or other team member allowing the task to be reassigned has confidence the team member can complete the task properly. Those are both necessary elements to fungibility that the PIC must consider as they seek to proactively assign tasks.

In an embodiment for example, tasks are divided into the following categories: (1) tasks that can be performed by any team member including administrative team members; (2) tasks that can be performed by team members with a minimum level of clinical training (e.g., a nurse assistant) or higher; (3) tasks that can be performed by team members with any level of decision making/prescribing authority (e.g., nurse practitioner, physician's assistant, or physician), and (4) tasks that can be performed by a physician only.

In an embodiment, tasks are identified, as described above, using process mining to process data and infer tasks. For example, the data to be processed can be provided by experience with healthcare facilities, including Military Treatment Facilities (MTFs). These sources include ICD data, lab data, pharmacy data, ED notes, Radiology, and dictations, among other data that may be potentially available to be mined and harnessed. Using this data, inferences can be made as to what tasks are required for a particular patient. For example, the data can be analyzed to determine the likely diagnosis for a patient, and then apply in-house best practices to identify a task list for the diagnosis. As another example, tasks can be identified as an organization process.

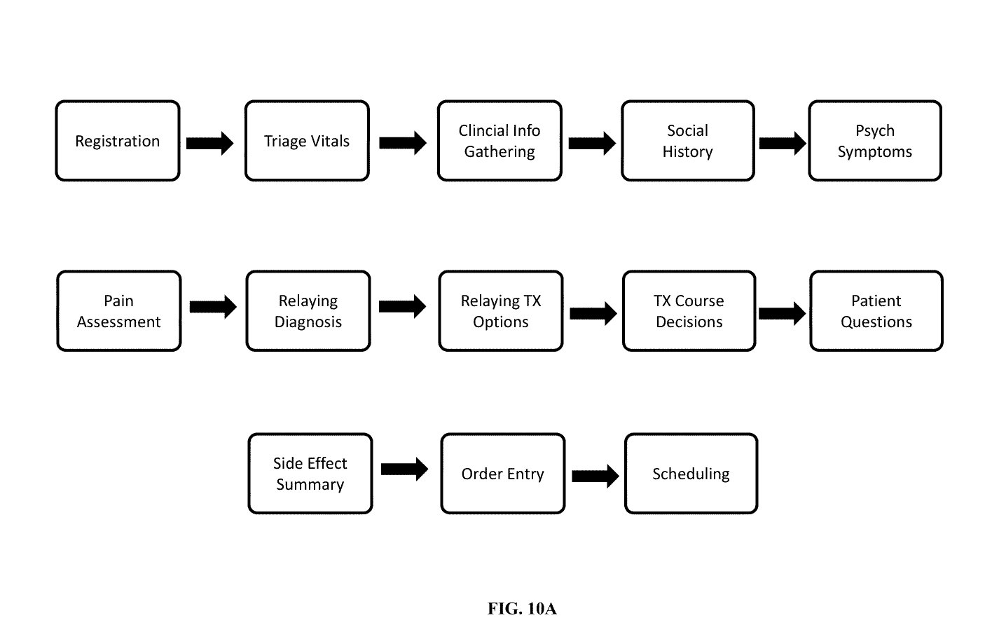

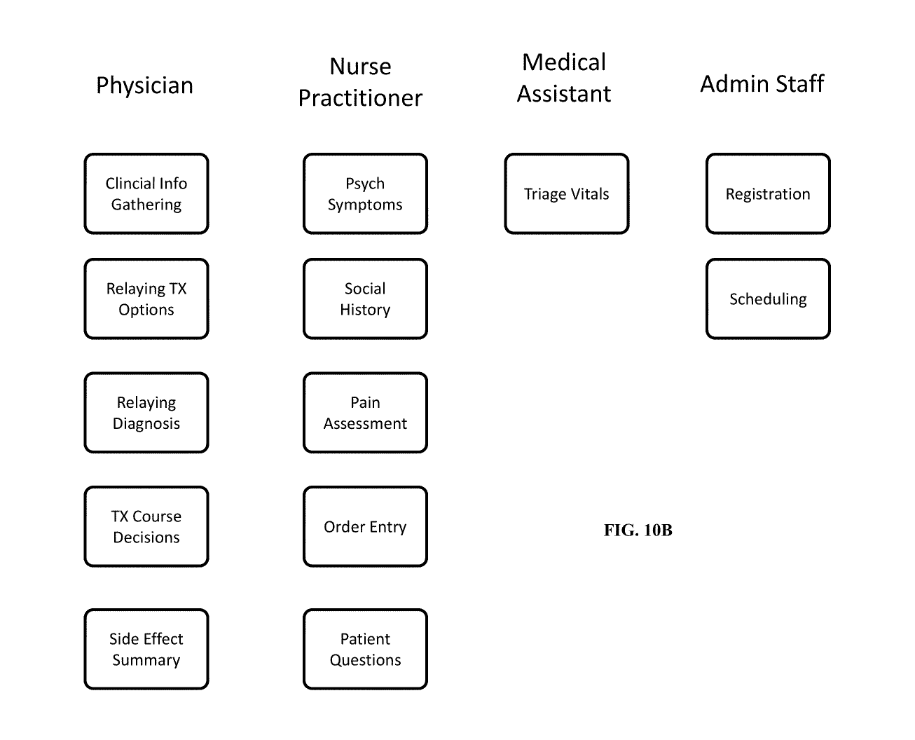

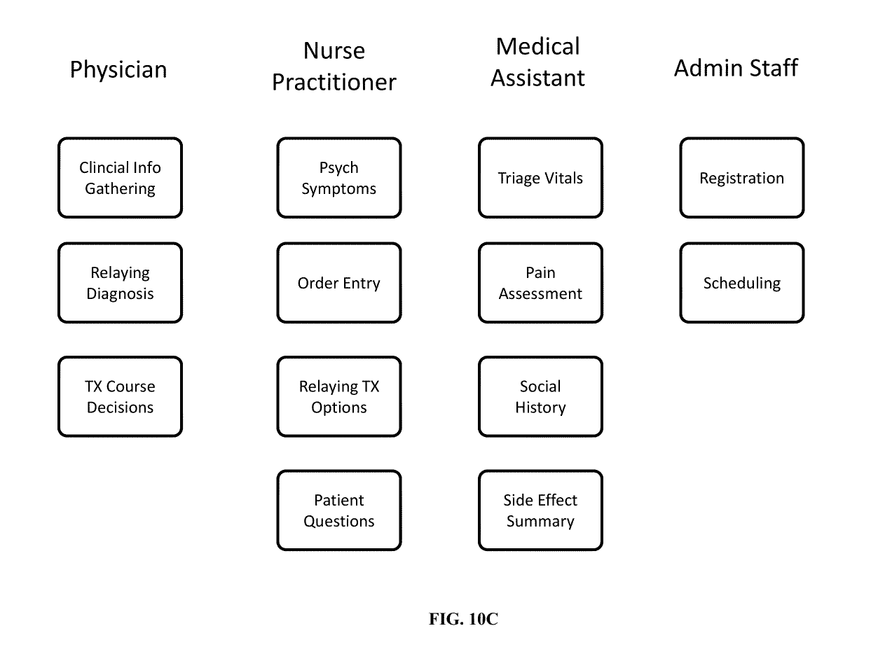

For example, FIG. 10A illustrates exemplary tasks that are performed in a healthcare facility for a particular patient. As shown, in FIG. 10A, the exemplary tasks are: registration, triage vitals, clinical information gathering, social history, psychological symptoms, pain assessment, relaying diagnosis, relaying treatment options, treatment course decisions, patient questions, side effect summary, order entry, and scheduling.

FIG. 10B illustrates how the tasks shown in FIG. 10A might be assigned to an exemplary healthcare provider team according to a conventional allocation. As illustrated in FIG. 10B, the healthcare provider team includes a physician, a nurse practitioner, 2 medical assistants and one administration staff person. As shown in FIG. 10B, the conventional allocation is not load balanced, which can lead to overload and task failure, as well as an inability to learn additional or reaffirm known tasks effectively. That is, the imbalanced load task allocation of FIG. 10B is likely to increase tasks at risk.

Using embodiment of the present invention, analysis and modeling enables prediction of where cognitive overloads have led to task failures, how often, and with what cost and consequence. For example, root cause analysis (RCA) can be used to determine which tasks are have historically failed and which person failed (which then, typically in the past, would lead to more training for that individual. However, by incorporating cognitive overload calculations into the RCA process, this drives the cross-training and process redesign that should occur to minimize tasks at risk by identifying when and where cognitive overload will likely lead to dropping of high value tasks.

The identified tasks are then examined on a concurrent basis by the PIC. As the PIC knows which personnel have historically failed at high value tasks (i.e. tasks-at-risk), they can look at current load levels that they can calculate. This calculation can be done to varying degrees of effectiveness, depending on whether manual (coarse) methods are used, such as looking at certain pieces of information gathered from tasks done in a checklist, which then creates a “scoring model” (which can be manual or electronic) to then plan future tasks generally from process designs that do not change in practice daily (i.e. they just become new checklists or processes)—or instead more precise systems are available such as electronic systems that can use the scoring model to change tasks prioritization for each person on the team based on the overload calculations from the scoring model. This, in effect, creates a “dynamic checklist” of tasks for each person to execute to maximize the load balancing and thus high value task execution of the team. With this data, the PIC can reallocate tasks to ensure each team member is in their optimal load for both remembering and executing care delivery tasks, as well as the learning tasks that will lead to better execution in subsequent needs to apply the task. FIG. 10C illustrates the tasks shown FIG. 10B reallocated to create a balanced task load according to an embodiment.

Thus, in embodiments, the PIC can balance the load of tasks across a team, In which team members are also trainees on certain tasks they are learning in a practice-based learning situation. In this manner, tasks can be allocated to avoid overload, thereby meeting the load balancing requirement. Then, when the individual is in a subsequent post-training situation, their recall of when and how to perform the task, and to use it in creative problem solving, is optimal. This maximizes the chances of an ideal patient outcome.

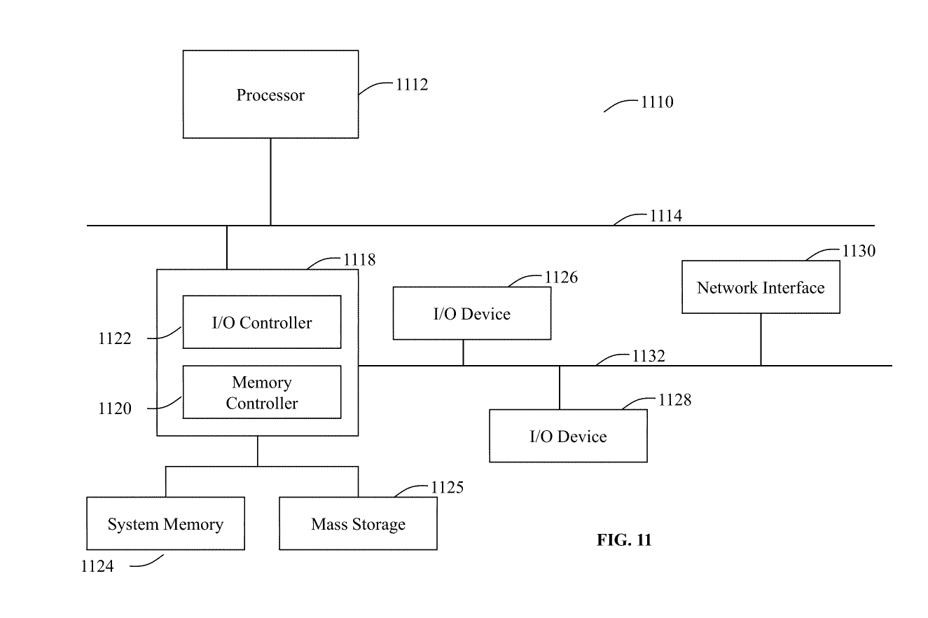

FIG. 11 is a block diagram of an example computer 1110 that may be used to implement the apparatus and methods described herein, including for example, system 500, method 600, according to an embodiment of the present invention. As shown in FIG. 11, computer 1110 includes a processor 1112 that is coupled to an interconnection bus 1114. Processor 1112 may be any suitable processor, processing unit or microprocessor. Although not shown in FIG. 11, system 1110 may be a multi-processor system and, thus, may include one or more additional processors that are identical or similar to processor 1112 and that are communicatively coupled to interconnection bus 1114.

Processor 1112 of FIG. 11 is coupled to a chipset 1118, which includes a memory controller 1120 and an input/output (“I/O”) controller 1122. As is well known, a chipset typically provides I/O and memory management functions as well as a plurality of general purpose and/or special purpose registers, timers, etc. that are accessible or used by one or more processors coupled to the chipset 1118. The memory controller 1120 performs functions that enable the processor 1112 (or processors if there are multiple processors) to access a system memory 1124 and a mass storage memory 11211.

System memory 1124 may include any desired type of volatile and/or non-volatile memory such as, for example, static random access memory (“SRAM”), dynamic random access memory (“DRAM”), flash memory, read-only memory (“ROM”), etc. The mass storage memory 1125 may include any desired type of mass storage device including hard disk drives, optical drives, tape storage devices, etc.

The I/O controller 1122 performs functions that enable the processor 1112 to communicate with peripheral I/O devices 1126 and 1128 and a network interface 1130 via an I/O bus 1332. I/O devices 1126 and 1128 may be any desired type of I/O device such as, for example, a keyboard, a video display or monitor, a mouse, etc. Network interface 1130 may be, for example, an Ethernet device, an asynchronous transfer mode (“ATM”) device, an 802.11 device, a DSL modem, a cable modem, a cellular modem, etc. that enables processor system 1110 to communicate with another computer such as a local or remote computer.

While memory controller 1120 and I/O controller 1122 are depicted in FIG. 11 as separate blocks within chipset 1118, the functions performed by these blocks may be integrated within a single semiconductor circuit or may be implemented using two or more separate integrated circuits.

The foregoing disclosure of the preferred embodiments of the present invention has been presented for the purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may by varied and still remain within the spirit and scope of the present invention.

What is claimed is:

1. A method for managing cognitive bandwidth of a team of healthcare providers, comprising:
process mining to determine symptoms presented by a patient;
predicting healthcare delivery tasks required to treat the patient;
determining a cognitive bandwidth of each healthcare provider available to treat the patient by reviewing tasks assigned to each healthcare provider by considering healthcare delivery tasks and educational tasks assigned to each healthcare provider;
determining whether any of the healthcare delivery tasks or educational tasks are tasks at risk based on the determined cognitive bandwidth of each healthcare provider;
allocating any determined tasks at risk among the healthcare providers to avoid any of the healthcare providers from reaching a tipping point.

2. The method recited in claim 1, further comprising:
assigning the patient a patient care task;
determining whether the patient care task assigned to the patient is a task at risk; and
load balancing patient care tasks to ensure the task at risk is performed by the patient.

3. The method recited in claim 1, wherein the process mining uses a lexical analysis source of patient symptoms to obtain one or more symptoms presented by the patient.

4. The method of claim 3, wherein the lexical analysis source of patient symptoms includes one or more of a patient intake report, a patient intake interview, and an emergency room report.

5. The method of claim 3, wherein the healthcare delivery tasks are predicted based on the one or more symptoms presented by the patient.

6. The method of claim 1, further comprising allocating tasks at risk to ensure that no healthcare provider has too few tasks to perform.

7. The method of claim 1, further comprising allocating tasks at risk to ensure each healthcare provider has sufficient time to perform a task to avoid reaching a tipping point.

8. The method of claim 1, further comprising allocating tasks at risk to ensure no healthcare provider has too much time between performing tasks.

9. The method of claim 1, wherein predicting the healthcare delivery tasks comprises accessing a database using the symptoms presented by the patient to obtain a diagnosis consistent with the presented symptoms and to obtain a set of tasks to be performed to treat the diagnosis.

10. A system for managing cognitive bandwidth of a team of healthcare providers, comprising:
a healthcare demand module executing on a computer to perform process mining to determine symptoms presented by a patient and to predict healthcare delivery tasks required to treat the patient;
a healthcare supply module executing on the computer to determine a cognitive bandwidth of each healthcare provider available to treat the patient by reviewing tasks assigned to each healthcare provider by considering healthcare delivery tasks and educational tasks assigned to each healthcare provider;
a performance improvement coordinator module to determine whether any of the healthcare delivery tasks or educational tasks are tasks at risk based on the determined cognitive bandwidth of each healthcare provider and to allocate any determined tasks at risk among the healthcare providers to avoid any of the healthcare providers from reaching a tipping point.

11. The system recited in claim 10, wherein the performance improvement coordinator:
(i) assigns the patient a patient care task;
(ii) determines whether the patient care task assigned to the patient is a task at risk; and
(iii) load balances patient care tasks to ensure the task at risk is performed by the patient.

12. The system recited in claim 10, wherein the healthcare demand module accesses a lexical analysis source of patient symptoms to obtain one or more symptoms presented by the patient.

13. The system recited in claim 12, wherein the lexical analysis source is located on a second computer that is accessible via a network.

14. The method of claim 12, wherein the lexical analysis source of patient symptoms includes one or more of a patient intake report, a patient intake interview, and an emergency room report.

15. The method of claim 12, wherein the healthcare demand module predicts the healthcare delivery tasks based on the one or more symptoms presented by the patient.

16. The method of claim 10, wherein the performance improvement coordinator allocates tasks at risk to ensure that no healthcare provider has too few tasks to perform.

17. The method of claim 10, wherein the performance improvement coordinator allocates tasks at risk to ensure each healthcare provider has sufficient time to perform a task to avoid reaching a tipping point.

18. The method of claim 10, wherein the performance improvement coordinator allocates tasks at risk to ensure no healthcare provider has too much time between performing tasks.

19. The method of claim 10, wherein the healthcare demand module predicts the healthcare delivery tasks by accessing a database using the symptoms presented by the patient to obtain a diagnosis consistent with the presented symptoms and to obtain a set of tasks to be performed to treat the diagnosis.
